(19) United States
(12) Patent Application Publication
(10) Pub. No.: US 2011/0242261 A1
(43) Pub. Date: Oct. 6, 2011

(54) OPTICAL HEAD AND IMAGE FORMING APPARATUS

(75) Inventors: Kenichi KOMIYA, Kanagawa-ken (JP); Koji Tanimoto, Shizuoka-ken (JP); Daisuke Ishikawa, Shizuoka-ken (JP); Hiroyuki Ishikawa, Shizuoka-ken (JP); Kazutoshi Takahashi, Shizuoken (JP)

(73) Assignees: Kabushiki Kaisha Toshiba, Tokyo (JP); Toshiba Tec Kabushiki Kaisha, Tokyo (JP)

(21) Appl. No.: 13/073,468

(22) Filed: Mar. 28, 2011

Related U.S. Application Data
(60) Provisional application No. 61/320,290, filed on Apr. 1, 2010.

(51) Int. Cl. B41J 2/435

(52) U.S. Cl. 347/224

(57) ABSTRACT

An optical head includes a light-emitting element to emit light, a substrate to which the light-emitting element is fixed, a heat radiation member to which the substrate is fixed, a filling member filled between the substrate and the heat radiation member, and a lens to focus the light emitted from the light-emitting element.

### CROSS-REFERENCE TO RELATED APPLICATION(S)

This application is based upon and claims the benefit of priority from: U.S. provisional application 61/320290, filed on Apr. 1, 2010; the entire contents of which are incorporated herein by reference.

### FIELD

Embodiments described herein relate generally to an optical head and an image forming apparatus.

### BACKGROUND

An optical head emits light used for exposure of a photoreceptor. The optical head includes a light-emitting substrate, and the light-emitting substrate generates heat by the light emission. In order to suppress temperature rise of the light-emitting substrate, a heat radiation plate can bet attached to the light-emitting substrate. When a gap (air layer) exists between the light-emitting substrate and the heat radiation plate, the heat of the light-emitting substrate is difficult to be transferred to the heat radiation plate.

### DESCRIPTION OF THE DRAWINGS

FIG. 1 is a view showing an inner structure of an image forming apparatus.

FIG. 2 is an outer appearance view of an optical printer head of a first embodiment.

FIG. 3 is a sectional view of the optical printer head of the first embodiment.

FIG. 4 is a front view of a light-emitting element and a glass substrate in the first embodiment.

FIG. 5 is a schematic view of apart of an optical printer head including a bottom emission type light-emitting element in the first embodiment.

FIG. 6 is an enlarged view of a portion where a lens holder and a glass substrate overlap each other.

FIG. 7 is a schematic view of a part of an optical printer head including a top emission type light-emitting element in the first embodiment.

FIG. 8 is a schematic view of a part of an optical printer head including a bottom emission type light-emitting element in a modified example of the first embodiment.

FIG. 9 is a schematic view of a part of an optical printer head including a top emission type light-emitting element in a modified example of the first embodiment.

### DETAILED DESCRIPTION

According to an aspect, an optical head includes a light-emitting element to emit light, a substrate to which the light-emitting element is fixed, a heat radiation member to which the substrate is fixed, a filling member filled between the substrate and the heat radiation member, and a lens to focus the light emitted from the light-emitting element.

### First Embodiment

A first embodiment will be described with reference to the drawings.

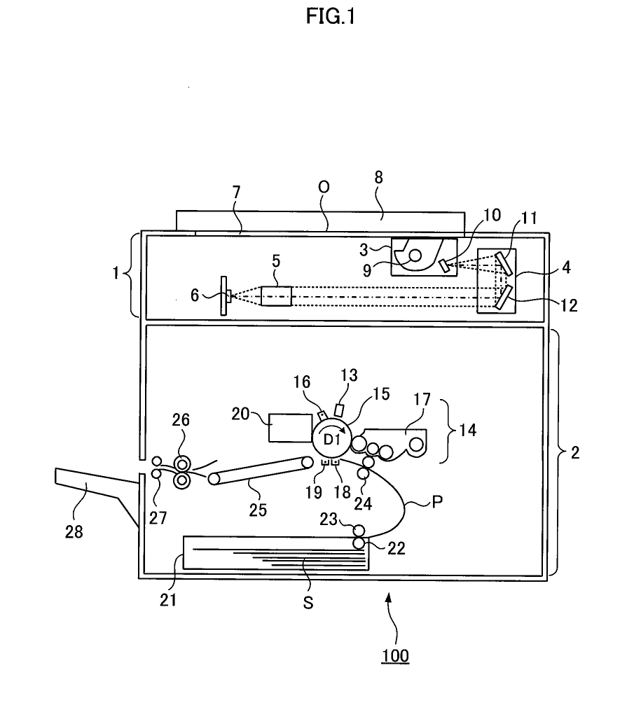

FIG. 1 is a view showing an inner structure of an image forming apparatus. The image forming apparatus 100 includes a scanner part 1 and a printer part 2. The scanner part 1 reads an image of a document O. The printer part 2 forms an image on a sheet.

The document O is placed on a document table glass 7. The read surface of the document O is directed downward and contacts the document table glass 7. A cover 8 rotates between a position where the document table glass 7 is closed and a position where the document table glass 7 is opened. When the cover 8 closes the document table glass 7, the cover 8 presses the document O to the document table glass 7.

A light source 9 emits light to the document O. The light of the light source 9 passes through the document table glass 7 and reaches the document O. The reflected light from the document O is reflected by mirrors 10, 11 and 12 in this order and is guided to a condensing lens 5. The condensing lens 5 focuses the light from the mirror 12, and forms an image on a light receiving surface of a photoelectric conversion element 6. The photoelectric conversion element 6 receives the light from the condensing lens 5 and converts it into an electric signal (analog signal).

An output signal of the photoelectric conversion element 6 is subjected to a specified signal processing, and then is outputted to an optical printer head 13 as an optical head. The specified signal processing is a processing of generating image data (digital data) of the document O. As the photoelectric conversion element 6, for example, a CCD sensor or a CMOS sensor can be used.

A first carriage 3 supports the light source 9 and the mirror 10, and moves along the document table glass 7. A second carriage 4 supports the mirrors 11 and 12, and moves along the document table glass 7. The first carriage 3 and the second carriage 4 independently move, and keep the light path length from the document O to the photoelectric conversion element 6 constant.

When the image of the document O is read, the first carriage 3 and the second carriage 4 move in one direction. While the first carriage 3 and the second carriage 4 move in the one direction, the light source 9 emits the light to the document O. The reflected light from the document O forms an image on the photoelectric conversion element 6 by the mirrors 10 to 12 and the condensing lens 5. The image of the document O is sequentially read one line by one line in the movement direction of the first carriage 3 and the second carriage 4.

The printer part 2 includes an image forming part 14. The image forming part 14 forms an image on a sheet S conveyed from a paper feed cassette 21. The plural sheets S received in the paper feed cassette 21 are separated one by one by a conveyance roller 22 and a separation roller 23, and are sent to the image forming part 14. The sheet S reaches a register roller 24 while moving along a conveyance path P. The register roller 24 moves the sheet S to a transfer position of the image forming part 14 at a specified timing.

A conveyance mechanism 25 moves the sheet S on which the image is formed by the image forming part 14 to a fixing unit 26. The fixing unit 26 heats the sheet S and fixes the image to the sheet S. A paper discharge roller 27 moves the sheet S on which the image is fixed to a paper discharge tray 28.

An operation of the image forming part 14 will be described.

The optical printer head 13, a charging unit 16, a developing unit 17, a transfer charger 18, a peeling charger 19 and a cleaner 20 are disposed around a photoconductive drum 15. The photoconductive drum 15 rotates in a direction of an arrow D1.

The charging unit 16 charges the surface of the photoconductive drum 15. The optical printer head 13 exposes the charged photoconductive drum 15. The optical printer head 13 causes plural light beams to reach exposure positions of the photoconductive drum 15.

When the light beams from the optical printer head 13 reach the photoconductive drum 15, the potential at the exposure portion is lowered, and an electrostatic latent image is formed. The developing unit 17 supplies a developer to the surface of the photoconductive drum 15 and forms a developer image on the surface of the photoconductive drum 15.

When the developer image reaches the transfer position by the rotation of the photoconductive drum 15, the transfer charger 18 transfers the developer image on the photoconductive drum 15 to the sheet S. The peeling charger 19 peels the sheet S from the photoconductive drum 15. The cleaner 20 removes a developer remaining on the surface of the photoconductive drum 15.

While the photoconductive drum 15 rotates, the formation of the electrostatic latent image, the formation of the developer image, the transfer of the developer image and the cleaning of the remaining developer image can be continuously performed. That is, the operation of forming the image on the sheet S can be continuously performed.

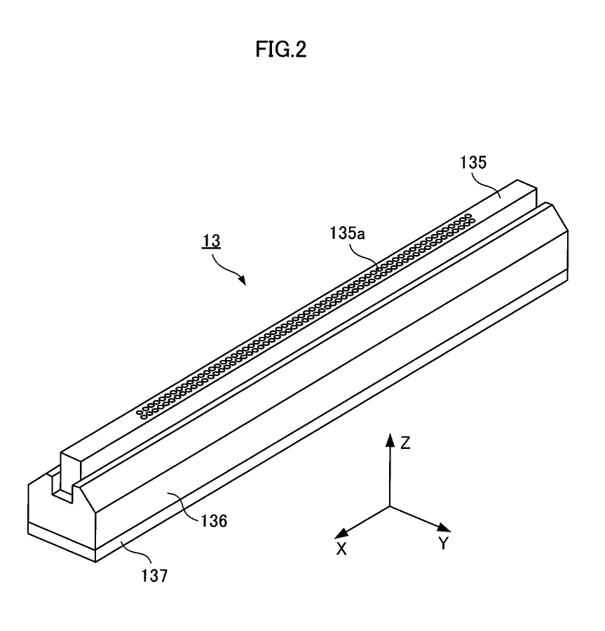

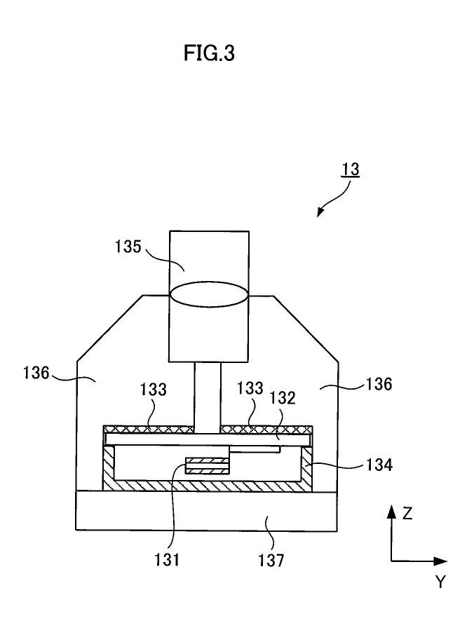

A structure of the optical printer head 13 will be described. FIG. 2 is an outer appearance view of the optical printer head 13, and FIG. 3 is a sectional view of the optical printer head 13. In FIG. 2 and FIG. 3, an X axis, a Y axis and a Z axis are axes perpendicular to each other. Also in the other drawings, the relation among the X axis, the Y axis and the Z axis is the same.

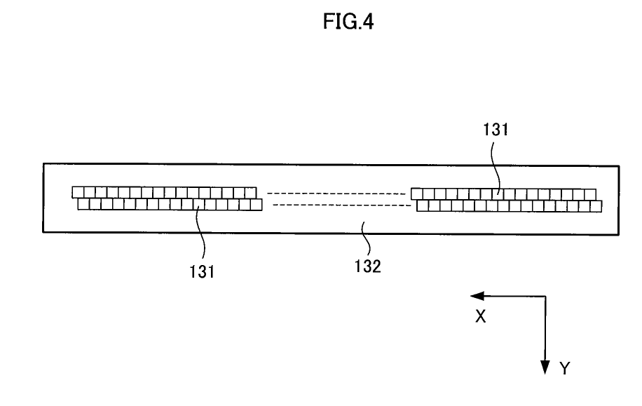

Light-emitting elements 131 are laminated on a glass substrate 132. As shown in FIG. 4, the plural light-emitting elements 131 are provided on the glass substrate 132. The plural light-emitting elements 131 are arranged in the longitudinal direction (X direction) of the glass substrate 132. Lines of the plural light-emitting elements 131 arranged in the X direction are arranged in the Y direction.

The glass substrate 132 is substantially transparent, and allows light to pass through. Although the glass substrate 132 is used in this embodiment, a substrate transparent to light can be used as well as the glass substrate 132. For example, instead of the glass substrate 132, a substrate formed of resin can be used.

The glass substrate 132 is fixed to a lens holder 136 as a heat radiation member with a grease 133. The grease 133 has thermal conductivity, and includes a wetter and a filler. As the wetter, for example, silicone can be used. The filler is used to improve heat conductivity, and a metal or metal oxide excellent in heat conductivity is used as the filler. For example, alumina (Al₂O₃), zinc oxide (ZnO) or boron nitride (BN) can be used as the filler. The heat conductivity of the filler is higher than the heat conductivity of the air or the wetter.

The lens holder 136 holds a SELFOC lens array 135. As shown in FIG. 2, the SELFOC lens array 135 includes plural SELFOC lenses 135a, and the plural SELFOC lenses 135a are arranged side by side along the longitudinal direction (X direction) of the glass substrate 132. In this embodiment, lines of the SELFOC lenses 135a arranged in the X direction are arranged in the Y direction.

The glass substrate 132 and a sealing member 134 form a receiving space for the light-emitting element 131. The sealing member 134 is fixed to the lens holder 136 and a cover 137. The cover 137 is fixed to the lens holder 136. The light-emitting element 131, the glass substrate 132 and the sealing member 134 are received in a space formed between the lens holder 136 and the cover 137.

Lights emitted from the light-emitting elements 131 are incident on the SELFOC lens array 135. The light emitted from each of the light-emitting elements 131 is incident on the corresponding SELFOC lens 135a.

The SELFOC lens array 135 focuses the plural lights (diffused lights) from the plural light-emitting elements 131 and causes them to reach exposure positions of the photoconductive drum 15. Spot lights with a desired resolution are formed at the exposure positions.

FIG. 5 is a schematic view showing a part of the optical printer head 13.

In this embodiment, a so-called bottom emission type organic EL element is used as the light-emitting element 131.

The light-emitting element 131 includes an anode 131a, a cathode 131b and a light-emitting layer 131c. The anode 131a is a transparent electrode for injecting a hole into the light-emitting layer 131c. The anode 131a can be formed of, for example, ITO (Indium Tin Oxide). The cathode 131b is an electrode for injecting an electron into the light-emitting layer 131c. The light-emitting layer 131c includes an organic material, and exists between the anode 131a and the cathode 131b.

When a DC voltage or a DC current is applied to the anode 131a and the cathode 131b, the anode 131a injects a hole into the light-emitting layer 131c. The cathode 131b injects an electron into the light-emitting layer 131c. In the light-emitting layer 131c, an electron state of an organic molecule is changed from a ground state to an excited state by the recombination of the hole and the electron.

The excited state is a higher energy state than the ground state. Since the excited state is an unstable state, the electron state of the organic molecule is returned to the ground state from the excited state. When the electron state is changed from the excited state to the ground state, energy is released and a light emitting phenomenon occurs in the light-emitting layer 131c.

The light generated in the light-emitting layer 131c is directed to the anode 131a and the cathode 131b. Since the anode 131a is the transparent electrode, the light from the light-emitting layer 131c passes through the anode 131a. The light directed to the cathode 131b is reflected by the cathode 131b, and is directed to the anode 131a. The light passing through the anode 131a passes through the glass substrate 132, and reaches the SELFOC lens array 135.

A transistor 131d as a switching element is laminated on the glass substrate 132, and is used to control the luminance of the light-emitting element 131. As the transistor 131d, for example, a TFT (Thin Film Transistor) can be used. Plural transistors 131d can be provided for the one light-emitting element 131.

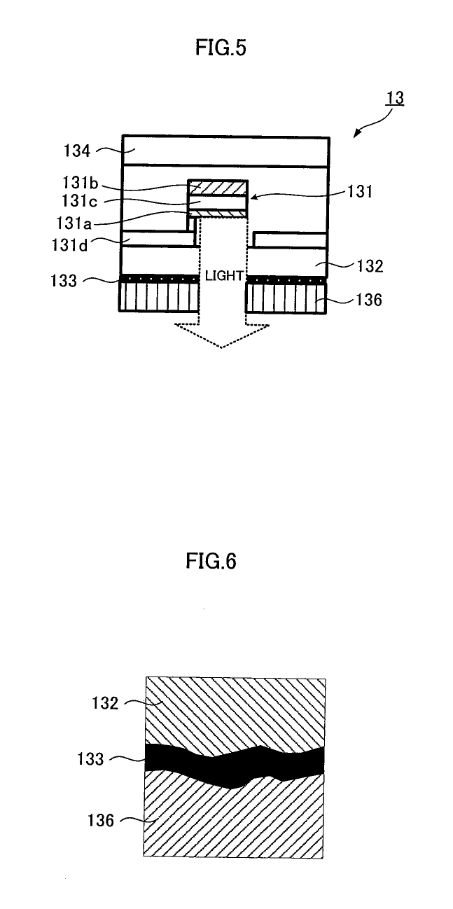

The layer of the grease 133 exists between the glass substrate 132 and the lens holder 136. As shown in FIG. 6, the grease 133 fills a gap formed between the glass substrate 132 and the lens holder 136. That is, the grease 133 directly contacts the glass substrate 132 and the lens holder 136. When the surfaces of the glass substrate 132 and the lens holder 136 are enlarged and are observed, as shown in FIG. 6, the surfaces of the glass substrate 132 and the lens holder 136 have irregularities. Besides, the thickness of the grease 133 is larger than the size of the irregularities of the glass substrate 132 and the lens holder 136.

The grease 133 fills the concave parts formed on the surfaces of the glass substrate 132 and the lens holder 136, and an air layer is not formed between the glass substrate 132 and the lens holder 136.

When the light-emitting element 131 emits light, the light-emitting element 131 generates heat. The heat generated in the light-emitting element 131 is transmitted to the glass substrate 132. The heat transmitted to the glass substrate 132 is transmitted to the lens holder 136 through the grease 133.

According to this embodiment, the heat generated in the light-emitting element 131 can be efficiently transmitted not only to the glass substrate 132 but also to the lens holder 136. The glass substrate 132 and the lens holder 136 absorb the heat from the light-emitting element 131 and releases the heat to the outside (atmosphere). The lens holder 136 functions as a heat sink.

When the temperature rise of the light-emitting element 131 is suppressed, the deterioration of the light-emitting element 131 due to the heat can be suppressed, and the life of the light-emitting element 131 can be extended.

The light-emitting element 131 as the organic EL element is liable to be influenced by heat, the amount of light is halved by the temperature rise of the light-emitting element 131, and a luminance half period becomes short. In the optical printer head 13, in order to secure the required exposure amount, as compared with another equipment (for example, a display) for emitting light, an applied current is large, and the amount of self-heat generation is also large.

Since a slight gap formed between the glass substrate 132 and the lens holder 136 is also filled with the grease 133, the heat conduction from the glass substrate 132 to the lens holder 136 can be improved.

The irregularities formed on the surfaces of the glass substrate 132 and the lens holder 136 vary according to individual products. When the grease 133 is used, even if the irregular surface varies for individual products, the grease 133 can be disposed along the irregular surface.

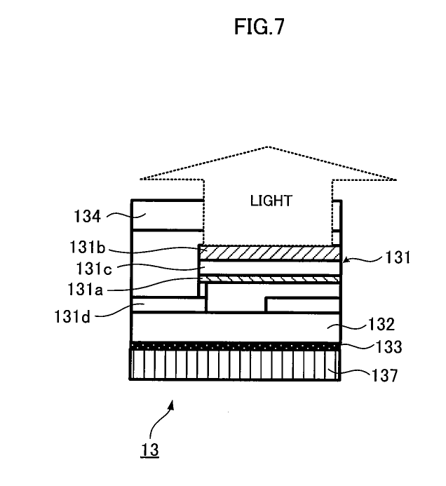

Although the light-emitting element 131 of this embodiment is the bottom emission type light-emitting element, a so-called top emission type light-emitting element can also be used. FIG. 7 is a schematic view of an optical printer head 13 using a top emission type light-emitting element.

In the bottom emission type light-emitting element 131, the anode 131a is the transparent electrode. However, in the top emission type light-emitting element 131, a cathode 131b is a transparent electrode. The cathode 131b as the transparent electrode can be formed of, for example, ITO (Indium Tin Oxide). When the cathode 131b is the transparent electrode, it is necessary to provide a metal for the cathode on an interface to an organic film.

Light generated in a light-emitting layer 131c is directed to an anode 131a and the cathode 131b. The light directed to the cathode 131b passes through the cathode 131b. The light directed to the anode 131a is reflected by the anode 131a and is directed to the cathode 131b. A sealing member 134 allows the light from the light-emitting element 131 to pass through. When the sealing member 134 is substantially transparent, the light can be emitted from the sealing member 134 without reducing the amount of light.

When the top emission type light-emitting element is used, since a block such as an electrode of a circuit is not disposed on the optical path, it is easy to ensure the light emitting area, and it is easy to ensure the amount of light.

In the structure shown in FIG. 7, heat generated in a light-emitting element 131 is transmitted in sequence of a glass substrate 132, a grease 133 and a cover 137. The cover 137 releases the heat from the light-emitting element 131 to the outside (atmosphere). The cover 137 functions as a heat sink.

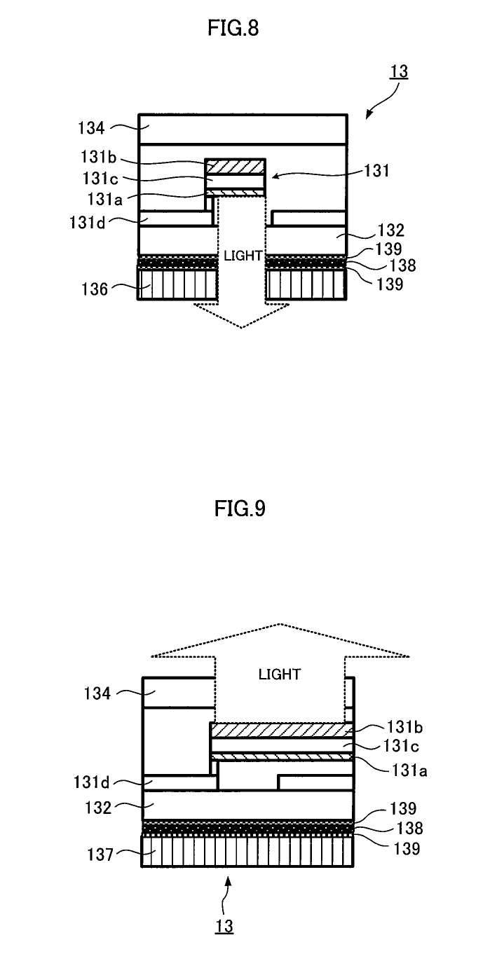

In this embodiment, the grease 133 is disposed between the glass substrate 132 and the lens holder 136. However, instead of the grease 133, for example, a heat conductive film 138 can be used as shown in FIG. 8. FIG. 8 is a view corresponding to FIG. 5.

The heat conductive film 138 includes adhesives 139 on surfaces respectively opposite to a glass substrate 132 and a lens holder 136. The heat conductive film 138 can be fixed to the glass substrate 132 and the lens holder 136 by using the adhesives 139.

The heat conductive film 138 may be simply held between the glass substrate 132 and the lens holder 136. When a mechanism to displace the glass substrate 132 and the lens holder 136 in a direction of approaching each other is used, the heat conductive film 138 is held between the glass substrate 132 and the lens holder 136 and is fixed.

As the heat conductive film 138, for example, a film in which a filler is mixed in silicone can be used. As the filler, ceramic, boron nitride (BN) , zinc oxide (ZnO) , alumina (Al₂O₃), silicon nitride (Si₃N₄) or aluminum nitride (AlN) can be used.

The heat conductive film 138 has only to have the heat conductivity higher than the heat conductivity of the air. The heat conductive film 138 can be deformed along the irregularities of the glass substrate 132 and the lens holder 136, it can fill a gap formed between the glass substrate 132 and the lens holder 136. Since the heat conductive film 138 fills the gap, heat conduction from the glass substrate 132 to the lens holder 136 can be accelerated.

In FIG. 8, although the heat conductive film 138 is used for the bottom emission type light-emitting element 131, as shown in FIG. 9, the heat conductive film 138 can be used also for a top emission type light-emitting element 131. FIG. 9 is a view corresponding to FIG. 7.

In the foregoing embodiment, although the grease 133 or the heat conductive film 138 is used, any material (filling member) may be used as long as it can be filled in the gap formed between the glass substrate 132 and the lens holder 136. It is preferable that the filling member is a material excellent in heat conductivity.

In this embodiment, although the heat generated in the light-emitting element 131 is released to the glass substrate 132 and the lens holder 136, a member for releasing the heat can be appropriately selected. When the heat generated in the light-emitting element 131 is transmitted to two members in sequence, the foregoing filling member can be provided between the two members.

In this embodiment, although the grease 133 or the heat conductive film 138 is provided in the whole area where the glass substrate 132 and the lens holder 136 face each other, the grease 133 or the heat conductive film 138 may be provided only in a partial area.

Incidentally, in this embodiment, the fixing includes fitting into a socket or the like.

While certain embodiments have been described, these embodiments have been presented by way of example only, and are not intended to limit the scope of invention. Indeed, the novel optical printer head described herein may be embodied in a variety of other forms; furthermore, various omissions, substitutions and changes in the form of the optical printer head described herein may be made without departing from the spirit of the inventions. The accompanying claims and their equivalents are intended to cover such forms or modifications as would fall within the scope and spirit of the inventions.

What is claimed is:

1. An optical head comprising:
a light-emitting element to emit light;
a substrate to which the light-emitting element is fixed;
a heat radiation member to which the substrate is fixed;
a filling member filled between the substrate and the heat radiation member; and
a lens to focus the light emitted from the light-emitting element.

2. The head of claim 1, wherein the filling member is a grease.

3. The head of claim 2, wherein the grease includes a wetter and a filler with a heat conductivity higher than the wetter.

4. The head of claim 1, wherein the filling member is a heat conductive film.

5. The head of claim 4, further comprising an adhesive provided on a surface of the heat conductive film.

6. The head of claim 1, wherein the light-emitting element includes
an anode that releases holes and allows light to pass through,
a cathode that releases electrons and reflects light, and
a light-emitting layer that receives the holes from the anode and the electrons from the cathode and emits the light.

7. The head of claim 6, wherein the light emitted from the light-emitting element passes through the substrate.

8. The head of claim 1, wherein the light-emitting element includes
an anode that releases holes and reflects light,
a cathode that releases electrons and allows light to pass through, and
a light-emitting layer that receives the holes from the anode and the electrons from the cathode and emits the light.

9. The head of claim 1, wherein the heat radiation member is a lens holder to hold the lens.

10. The head of claim 1, wherein the filling member directly contacts the substrate and the heat radiation member.

11. The head of claim 1, wherein a thickness of a layer of the filling member is larger than a size of irregularities of the substrate and the heat radiation member.

12. An image forming apparatus comprising:
a photoreceptor;
a light-emitting element to emit light;
a substrate to which the light-emitting element is fixed;
a heat radiation member to which the substrate is fixed;
a filling member filled between the substrate and the heat radiation member;
a lens to focus the light emitted from the light-emitting element to the photoreceptor; and
a developing unit to supply a developer to the photoreceptor.

13. The apparatus of claim 12, wherein the filling member is a grease.

14. The apparatus of claim 13, wherein the grease includes a wetter and a filler with a heat conductivity higher than the wetter.

15. The apparatus of claim 12, wherein the filling member is a heat conductive film.

16. The apparatus of claim 15, further comprising an adhesive provided on a surface of the heat conductive film.

17. The apparatus of claim 12, wherein the light-emitting element includes
an anode that releases holes and allows light to pass through,
a cathode that releases electrons and reflects light, and
a light-emitting layer that receives the holes from the anode and the electrons from the cathode and emits the light.

18. The apparatus of claim 12, wherein the heat radiation member is a lens holder to hold the lens.

19. A method of manufacturing an optical head, comprising:
disposing a filling member on at least one of a substrate to which a light-emitting element is fixed and a heat radiation member; and
overlapping the substrate and the heat radiation member to cause the filling member to be held between the substrate and the heat radiation member.

20. The method of claim 19, wherein the filling member is a grease.
